(19) United States
(12) Patent Application Publication
(10) Pub. No.: US 2012/0222766 A1
(43) Pub. Date: Sep. 6, 2012

(54) FLEXIBLE HOSE WITH WEAR INDICATOR

(76) Inventors: Gus Alexander, Inverness, IL (US); John J. Pianetto, Hoffman Estates, IL (US)

(21) Appl. No.: 13/039,529

(22) Filed: Mar. 3, 2011

(51) Int. Cl. F16L 11/00; F16L 55/00

(52) U.S. Cl. 138/36; 138/137

(57) ABSTRACT

The present disclosure relates to a flexible hose that has an outer jacket which includes a continuous layer and a plurality of protrusions extending radially outward from the continuous layer. The protrusions are in spaced relation to one another and extend along a longitudinal axis of the hose. When one of the at least one protrusions is abraded, a greater portion of the continuous layer is revealed in an area below the abraded protrusion, indicating that the continuous layer is susceptible to potentially damaging wear.

### BACKGROUND

1. Field of the Disclosure

The present disclosure relates to hoses and more specifically to flexible hoses with a wear indicator for use in abrasive environments. The present disclosure also relates to a method for detecting wear in the outer jacket of a hose.

2. Description of the Related Art

Hoses are used in a variety of environments and are exposed to a variety of conditions. Accordingly, over time the outer layer or jacket of hoses may be worn away and if not addressed, ultimately may lead to hose failure, potentially including leakage and/or rupture during use. For example, hoses used in connection with pressure washing apparatus are frequently pulled or dragged across rough surfaces, such as concrete floors and roads, during use and transport of the pressure washer.

In order to address hose wear and increase the longevity of a hose, a protective outer cover or jacket has been added to the hose. However, these jackets can not perpetually prevent against wear and eventually the hose may become worn and susceptible to failure. Also, the addition of material to form a full protective outer cover or jacket stiffens a hose which may tend to make it less flexible than desired or demanded by users.

One shortcoming of present hoses is that it is not immediately apparent to the user that the hose they are using is suffering from wear that may have reduced the structural integrity of the hose. Accordingly, it is not uncommon for the user of a hose to be surprised by an unserviceable hose, whether it be completely ruptured or simply leaking.

While there are some hoses that provide notification of wear of an outer cover or jacket, the user has no pre-notification of what they should be looking for to identify potential excessive wear. Therefore, the user may not be aware that there is a certain wear indicator layer that when encountered actually indicates that the wear has potentially breached the structural integrity of the hose. In addition, hoses with a continuous outer layer over a further wear indicator layer limit the flexibility of the hose and may create a hose that is less flexible than desired or demanded by its users.

### SUMMARY

In a first aspect, the present disclosure relates to a flexible hose including an outer jacket. The outer jacket includes a continuous layer having a plurality of protrusions extending radially outward from the continuous layer. The hose also includes a center core separate from and disposed within the outer jacket. The protrusions are in spaced relation to one another and extend parallel to a longitudinal axis of the hose.

In a second aspect, the present disclosure relates to a flexible hose including an outer jacket having at least one indicator surface area and at least one wear surface area. The at least one indicator and at least one wear surface areas are positioned adjacent one another. The hose also includes a center core disposed within the outer jacket. The indicator surface area is defined by an exposed surface of a continuous layer. The wear surface area is defined by an exposed surface of a protrusion having a raised surface area relative to the indicator surface area. The protrusion extends radially outward from the continuous layer. The indicator area provides notice to a user of the continuous layer that will be exposed when at least a portion of the protrusion is worn through to expose the underlying continuous layer.

Another aspect of the present disclosure relates to a method of detecting wear in an outer cover of a hose. The method includes the step of providing a hose having an outer jacket including a continuous layer and a plurality of longitudinally extending protrusions extending radially outward from the continuous layer with the protrusions being in spaced relation to one another. The method further includes the step of observing the exposed surface of the continuous layer before use of the hose. The method further includes the step of abrading a portion of at least one of the protrusions wherein t more of the continuous layer is revealed in an area below the at least one protrusion.

### BRIEF DESCRIPTION OF THE DRAWINGS

The above-mentioned and other features of the invention, and the manner of attaining them, will become more apparent and will be better understood by reference to the following description of examples of the invention taken in conjunction with the accompanying drawings, wherein:

FIG. 1 is a side elevation view, partially cut away, of a first example of a flexible hose with a wear indicator;

FIG. 2 is a cross-sectional view of the hose shown in FIG. 1 taken in the plane of line A-A;

FIG. 3 is a further cross-sectional view of the hose shown in FIG. 1 with at least part of the several protrusions worn away and revealing an underlying continuous layer;

FIG. 4 is an exploded view of a portion of the hose shown in FIG. 2;

FIG. 5 is a plan view of the hose shown in FIG. 1 when the hose is bent through an angle of 180°; and

FIG. 6 is a cross-sectional view of a second example of a hose wherein the protrusions and continuous layer are integrally formed.

Corresponding reference numerals indicate corresponding parts throughout the several views. The present disclosure illustrates examples that are not to be construed as limiting the scope of the claims set forth herein in any manner.

### DETAILED DESCRIPTION

Detailed examples of the present subject matter are disclosed herein; however, it will be understood that the disclosed examples are merely exemplary, and may be embodied in various forms. Therefore, specific details disclosed herein are not to be interpreted as limiting, but are illustrative of various aspects of the present subject matter.

As described in more detail in the discussion of the different example hoses, the present disclosure is directed to flexible hoses and more specifically to flexible hoses which may be used in abrasive environments. The flexible hoses 10 illustrated in the figures are intended to be used in connection with a pressure washing apparatus (not shown). It will be appreciated that such a hose may be used with other desired equipment or in other environments. In use, one end of the hose 10 may be connected to an outlet of a pump of a pressure washing apparatus and the other end of the hose 10 may be connected to a wand or other device which includes a nozzle for directing pressurized fluid from the pump of the pressure washing apparatus. The hose 10 may include conventional fittings or couplings (not shown) on ends thereof which allow the hose to be connected to the outlet and wand to form appropriate fluid-tight connections therebetween.

In a first example, hose 10 generally includes an outer jacket 12. The outer jacket 12 includes a plurality of spaced apart protrusions 20 which extend radially outward from a continuous layer 40. The protrusions 20 extend longitudinally parallel to a central axis “A” of the hose 10 and define grooves 60 therebetween. The continuous layer 40 has exposed surfaces 42 which form the floor of the respective grooves 60. The exposed surfaces 42 are always visible to the user at least within the grooves 60.

In this example, the hose 10 also includes a center core 14 disposed within the outer jacket 12, and a reinforcing layer 16 disposed between the center core 14 and the outer jacket 12. This hose construction provides a user with pre-notification of the depth of the exposed surface 42 that acts as an indicator surface area. The protrusions 20 protect the continuous layer 40 and permit some wear in the outer jacket before a user must be concerned about harming the structural integrity of the hose 10. Thus, once a portion of at least one of the protrusions 20 is worn away, such that the underlying continuous layer 40 with its surface being co-extensive of the exposed surfaces 42 is exposed, the user is able to identify that undesirable wear of the outer jacket 12 has occurred and there is a potential need to replace the hose 10. The combination of the exposed surfaces 42 in the grooves 60 and the thickness ‘T” of the protrusions 20 provides an early warning system to the user for detecting reduced integrity of, and therefore potentially dangerous wear of, the outer jacket. Pre-exposure of the continuous layer 40 via the indicator surface area provided by the exposed surface areas 42 on the floor of the grooves 60 provides the user with notice of the outer surface that they should be watching for or aware of as the raised wear surface areas provided by the protrusions 20 of the hose 10 are worn. Accordingly, a user is provided notice of the undesirable wear of the hose 10 when the user sees an increase in the cylindrical exterior surface area of the continuous layer 40.

While the illustrated hose 10 includes an outer jacket 12, a central core 14 and reinforcing layer 16, it will be appreciated that the central core 14 and reinforcing layer 16 may be omitted, or alternatively, additional layers may be included. For example, the hose may be constructed to only have an outer jacket 12 or may have additional layers between the center core 14 and outer jacket 12. Some examples of materials that may be used for the outer jacket 12, center core 14, and reinforcing sheath 16 are more fully described in U.S. Pat. No. 5,964,409, U.S. Pat. No. 7,222,644, and U.S. Publication No. 2008/0105283, all of which are hereby incorporated by reference in their entireties.

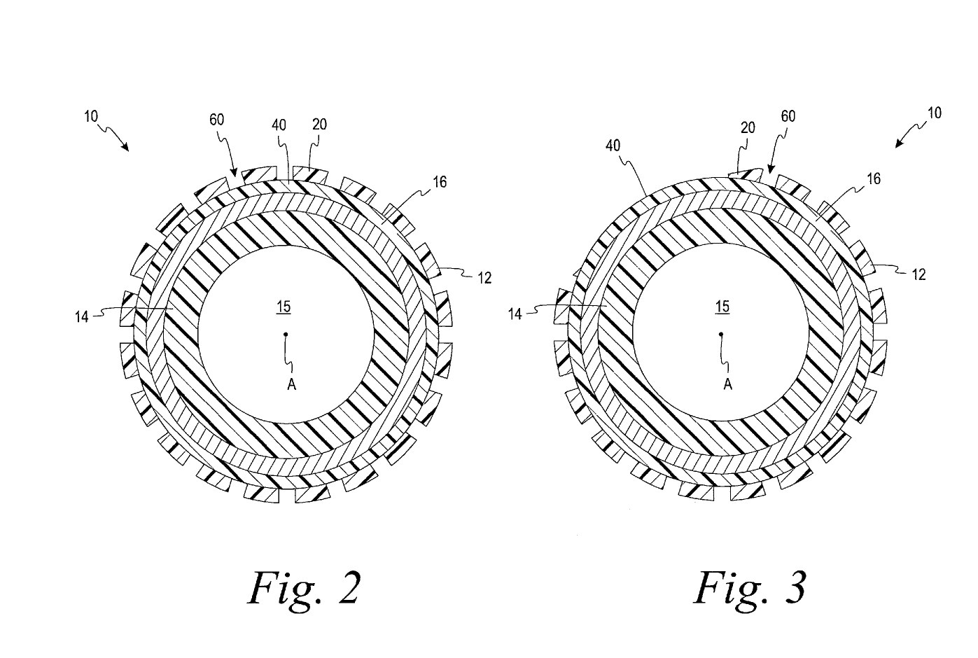

In the exemplary hose 10, the center core 14 has an annular cross section (see FIG. 2) and defines a fluid carrying conduit 15 that is sized and configured for transporting fluids such as high-pressure water or any other desired fluid. In this example, the dimensions may include the fluid carrying conduit 15 having a diameter ranging from about 6.35 mm to about 9.2 mm and the thickness of the center core 14 ranging from about 0.9 mm to about 1.8 mm. However, these dimensions may be varied to accommodate different materials, types of fluids, desired capacities, temperatures, or pressures of desired fluids. The center core 14 typically is extruded; however, alternative methods of construction may be used.

The center core 14 is constructed of a flexible material, preferably a thermoplastic polymeric material, which is capable of accommodating pressurized fluids of at least about 1,000 psi while maintaining a high degree of flexibility when fluid is not in the hose and the hose is not pressurized. There are numerous materials that may be used for the center core 14 which include, for example, high tensile strength thermoplastic elastomers such as SANTOPRENE™ thermoplasitic vulcanizate (TPZ), reinforced polypropylene and nylons, and polyethylene. As mentioned previously, more examples of the materials and constructions for the center core 14 may be found in U.S. Pat. No. 5,964,409, U.S. Pat. No. 7,222,644, and U.S. Publication No. 2008/0105283. However, it should be appreciated that the present disclosure is not limited to the foregoing materials and constructions, and indeed any material and construction having suitable flexibility, strength and resistance to the intended fluid may be used to form a center core 14.

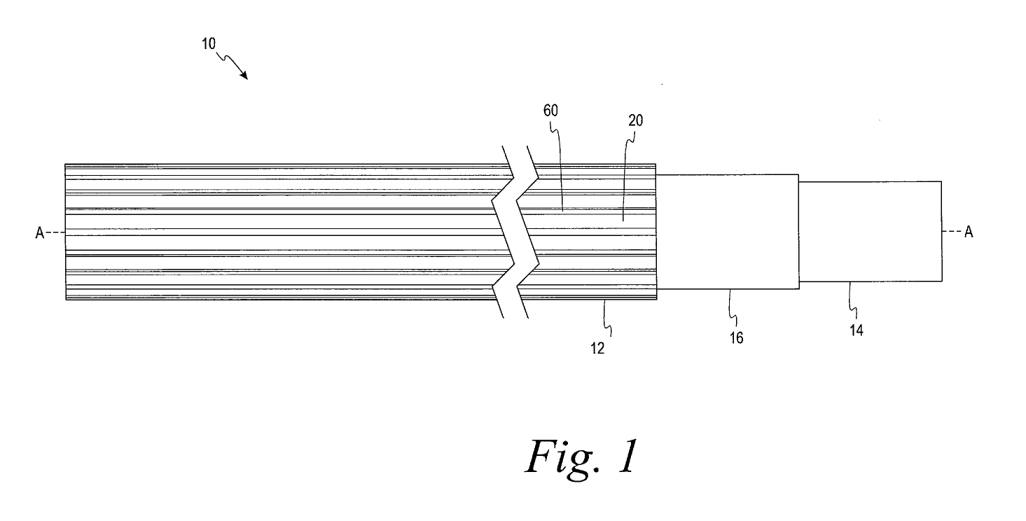

The exemplary hose 10 illustrated in FIGS. 1-5 includes a reinforcing layer 16 that covers and preferably is adhesively secured to the center core 14 to help increase the burst resistance of the overall hose. The reinforcing layer 16 preferably is of a braided sheath construction, and thus includes interwoven strands of materials such as natural, synthetic and/or metallic fiber or wires. The reinforcing layer 16 may be a single braided fibrous sheath or multiple braided sheaths constructed of a single or combination of fiber or wire materials. Alternatively, the reinforcement layer 16 may be a helical strand or strands of material such as a coiled steel wire. The reinforcing layer 16 preferably has a thickness ranging from about 0.7 mm to about 1.8 mm, although other thicknesses also are contemplated by the present disclosure, depending upon the desired burst pressure of the hose.

Generally speaking, the reinforcing layer 16 is braided over the center core 14 after extruding the core, although other suitable methods of application may be utilized. In order to minimize the overall bulk of the reinforcing material, while at the same time maintaining flexibility of the hose, it has been discovered that the reinforcing layer 16 of the hose 10 of the present disclosure preferably should be braided at an angle of at least about 1.41 radians, and more preferably a braid angle ranging from about 1.41 radians to about 1.48 radians. It is understood that braiding the reinforcement layer at such higher braid angles than are conventionally employed (about 1.40 radians or less) provides a hose with a higher burst resistance while maintaining sufficient hose flexibility to allow for adequate use of the hose in applications such as consumer pressure washing, where a hose must be sufficiently flexible to be bent through a variety of configurations. More specifics as to the materials and constructions of the reinforcing layer 16 may be found in U.S. Pat. No. 5,964,409, U.S. Pat. No. 7,222,644, and U.S. Publication No. 2008/0105283. However, it should be appreciated that the present disclosure is not limited to the foregoing materials and constructions. Indeed any materials and constructions having suitable flexibility, strength and resistance may be used for the reinforcing layer 16.

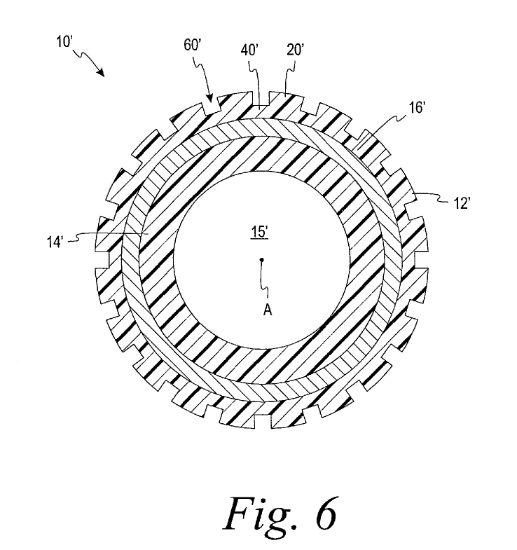

To help prevent damage to the reinforcing layer 16 and/or the center core 14 and to provide abrasion resistance of the hose during use, the hose 10 includes an outer jacket 12 positioned over the reinforcing layer 16. In the hose shown in FIGS. 1-5 the outer jacket 12 is of multi-part construction and includes a plurality of spaced apart longitudinally extending protrusions 20 connected to and extending from the continuous layer 40. In the hose shown in FIG. 6 which is discussed more fully below, the outer jacket 12′ is of one-piece construction and includes a plurality of spaced apart longitudinally extending protrusions 20′ extending from the continuous layer 40′.

The outer jacket 12 preferably is constructed of abrasion-resistant, flexible material, such as high tensile strength thermoplastic elastomers, reinforced polypropylene and nylons, and polyethylene. It will be appreciated that the continuous layer 40 and the protrusions 20 do not have to be constructed of the same material and the protrusions 20 serve to also protect the continuous layer 40 until a protrusion 20 is subjected to wear sufficient to see the underlying continuous layer 40. In addition, the material or materials of the outer jacket 12 may be similar or dissimilar to the material of the center core 14. As mentioned previously, more detail regarding potential materials of the outer jacket 12 may be found in U.S. Pat. No. 5,964,409, U.S. Pat. No. 7,222,644, and U.S. Publication No. 2008/0105283. However, it should be appreciated that the present disclosure is not limited to the foregoing materials and indeed any material having suitable flexibility, strength and abrasion resistance can be used in conjunction with the outer jacket 12 or portions thereof.

The outer jacket 12 preferably has an overall thickness ranging from about 1.0 mm to about 1.6 mm, although other thicknesses also are contemplated by the present disclosure, depending upon the desired protection and/or abrasion resistance. The outer jacket 12 may be bonded or otherwise adhesively secured to the reinforcement layer 16, if any, with sufficient adhesive to impart adhesion between the outer jacket 12 and the reinforcement layer 16, preferably sufficient to provide an adhesive strength adequate to prevent separation between the outer jacket 12 and the reinforcement layer 16 when the hose 10 is bent or otherwise manipulated.

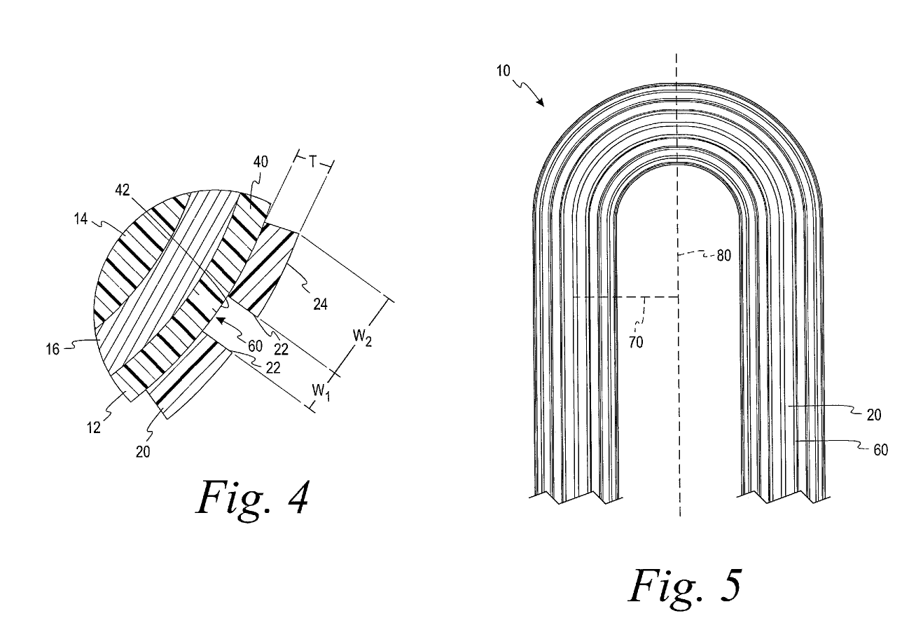

The continuous layer 40 of the illustrated exemplary hose 10 surrounds and covers the entire reinforcing layer 16. The continuous layer 40 has an exterior surface 42 which is exposed between the protrusions 20 which extends radially outward from the continuous layer 40. The continuous layer 40 preferably has a thickness of about 0.5 mm, although other thicknesses also are contemplated by the present disclosure depending upon the protection of the reinforcing layer 16 and center core 14 that is desired. In the example hose 10, as best seen in FIG. 4, the continuous layer 40 having the exposed indicator surface 42 has a width “W₁” of about 0.6 mm. In this example the continuous layer 40 of the outer jacket 12 is extruded over the reinforcing layer 16. Also, it will be appreciated that the continuous layer 40 could be formed of a single or multiple extruded layers.

In the example hose 10 illustrated in FIGS. 1-5, there are twenty protrusions 20 equally spaced around the perimeter of the hose. It will be appreciated that other numbers and spacing of the protrusions 20 are contemplated by the present disclosure. The protrusions 20, best illustrated in FIGS. 2 and 4 have a generally rectangular shape and extend radially outward from the continuous layer 40 and longitudinally in a pattern that is generally parallel to the central axis “A” of the hose. More specifically, the protrusions 20 have side walls 22 and a top surface 24 that is generally convex, but the protrusions 20 may be considered to have a generally rectangular shape. However, it will be appreciated that the protrusions 20 may be of other shapes and may not extend linearly and parallel to the central axis of the hose 10. In addition, not all of the protrusions must have the same shape, as some may have different shapes than others. The illustrated protrusions 20 have a thickness “T” of about 0.49 mm and a width “W₂” of about 1.56 mm, which is measured between the grooves 60, although other thicknesses and widths also may be used. In addition, while all of the protrusions 20 in the illustrated example have the same thickness T and width W₂, it will be appreciated that protrusions on a hose can have varying thicknesses or widths, if desired. Preferably, the protrusions have a common thickness along their lengths; however it will be appreciated that the protrusions thicknesses may vary along their lengths, if desired.

In the example hose 10, a groove 60 is defined between every two spaced apart protrusions 20. The sides of the groove 60 are defined, at least in part, by side walls 22 of the adjacent protrusions 20. It will be appreciated that the groove 60 could extend into the continuous layer 40, such that the exterior surface of the continuous layer is not strictly cylindrical, while not departing from the spirit or scope of the present disclosure. As noted above, the floor of the groove 60 is defined by the exposed surface 42 of the continuous layer 40, thereby serving as an indicator surface area. In the illustrated example the exposed surface 42 has a generally flat configuration, although other configurations, such as flat or concave surfaces, are possible. Like the protrusions 20, the grooves 60 extend longitudinally parallel to the central axis “A” and preferably along the entire length of the hose 10. In this example, the grooves 60 extend in a continuous linear manner; however, it will be appreciated that the grooves could extend in a segmented and/or non-linear manner.

Methods for fabricating the outer jacket 12 of the present hose 10 include two-part extrusion process typically known as “cross-head” extrusion. The “cross-head” extrusion method would involve first extruding the continuous layer 40 over the reinforcing layer 16, and then extruding the protrusion 20 thereover. Alternatively, other coextrusion methods of fabrication may be utilized. Coextrusion involves utilizing two extruders at once, thereby forming both the continuous layer and protrusions extending therefrom simultaneously. This method utilizes two sets of extruders that are combined so as to share a set of extrusion dies in an assembly having two concentrically arranged annular orifices. One of the two extruders is connected to the inner orifice of the die while the other extruder is connected to the outer orifice of the die. The two extruders are operated simultaneously such that the continuous layer and protrusions come into contact with each other while both of the materials are in a plasticized state and are not yet exposed to the atmosphere, thereby promoting their adhesion to one another.

Although the above described simultaneous coextrusion method is preferable, the outer jacket 12 also may be produced by a familiar two-stage extrusion method. As such, the continuous layer 40 may be formed by an ordinary extrusion technique as a first step, and then an outer surface of the continuous layer 40 may be coated with a layer of an adhesive. Thereafter, the plurality of protrusions 20 may be added to the hose.

FIG. 6 illustrates a second example hose 10′ that generally includes an outer jacket 12′, center core 14′ and reinforcing layer 16′. Like the hose illustrated in FIGS. 1-5, the outer jacket 12′ includes a plurality of spaced apart protrusions 20′ which extend radially outward from a continuous layer 40′, however, the protrusions 20′ and continuous layer 40′ are integrally formed. Accordingly, the entire outer jacket 12 may be fabricated in a single step using a single extruder.

While discussed with respect to the first example hose 10 in FIGS. 1-5, it will be appreciated that the second example in FIG. 6 also would provide a user of a hose having a constant pre-notification via an indicator surface area that is associated with the generally cylindrical continuous layer 40 of the outer jacket 12 and which will have an increased area showing when at least a portion of one of the protrusions 20 has been worn through to expose the underlying continuous layer 40. The pre-notification is provided by the difference in the depth of the grooves 60 from the raised wear surface of the protrusions 20 to the exposed surfaces 42 of the continuous layer 40. Thus, portions of the continuous layer 40 always are exposed to the user because the exposed surfaces 42 form the floor of the grooves 60. The protrusions 20 have a thickness “T”, and therefore, a raised wear surface area. Preferably, the grooves 60 and protrusions 20 are symmetrically spaced and sized to provide a uniform look along the length of a hose 10.

When at least a portion of the protrusions 20 is worn away and the underlying continuous layer 40 is exposed, the further exposure of the underlying continuous layer results in a more cylindrical look to the hose 10. This more cylindrical look indicates to the user that the continuous layer 40 of the hose 10 is subject to wear and further wear would risk breaching the integrity of the outer jacket 12. In this manner, the use of the raised wear surface areas of the protrusions 20 and the relative visible indicator surface areas of the exposed surfaces 42 on the floor of the grooves 60 act as an early warning system to the user for detecting wear that may be damaging to the integrity of the hose. In the hose of either example, pre-exposure of the exposed surface 42 provides the user with advanced notice of the generally cylindrical continuous layer 40 that will show more prominently when the outer jacket 12 and more specifically, the outer surface of the continuous layer 40 is further exposed by excessive wear of one or more protrusions 20 of the hose 10.

It will be appreciated that the continuous layer and protrusions, or portions thereof may be constructed of an opaque or optically-transparent or translucent material that is blended with any commercially available dye to color the portions. In addition, if desired, portions of the outer jacket may be blended with other ingredients to obtain other desired characteristics, such as protection against UV effects.

Not only do the protrusions 20 and grooves 60 provide a pre-notification of hose wear, they also increase the overall flexibility of a hose compared to a hose with an outer jacket having two continuous layers or one thicker continuous layer. The hoses of the present disclosure preferably have a minimum bend radius no greater than about 10 times the radius of the hose, and preferably in the range from 6.5 to 8.25 times the radius of the hose. The minimum bend radius is determined by bending a hose with no fluid contained therein over an angle of 180° and by reducing the size of the bend to as small a diameter as possible without kinking the hose, as shown, for example, in FIG. 5. The minimum bend radius 70 of the hose 10 may be defined as the distance between the central bend line 80 of the bent portion of the hose 10 and the center of the hose, the distance being measured along an angle normal to the bend line 80. By incorporating a flexible material in the core of the hose of the present disclosure, a high-pressure hose having a minimum bend radius no greater than about 38 mm while maintaining the ability to accommodate high pressures may be provided. In preferred embodiments, the present disclosure provides a hose that is sized such that the hose has a minimum bend radius no greater than about 36 mm. More preferably, the minimum bend radius is no greater than about 34 mm, and even more preferably, the minimum bend radius is no greater than about 30 mm. The high-pressure hoses will thus be sufficiently flexible for use in consumer pressure washing applications and other high-pressure applications.

Hoses of the present disclosure preferably have a burst rating that is sufficiently below their burst pressure to leave a 300% margin of safety between the rated pressure and the actual burst pressure. The burst pressure of the hose is the gauge pressure that the hose will accommodate before bursting. Thus, for example, a hose having a burst rating of 300 psi will have a burst pressure of at least about 900 psi, it being understood that the hose will accommodate pressures of at least 1000 psi, and possibly much higher pressures, before bursting.

To ensure the structural integrity of the hose, it is preferable that the hose have a minimum impulse value of at least about 10,000 cycles, more preferably, at least about 20,000 cycles, and most preferably, at least about 30,000 cycles. The impulse value is conventionally defined and refers to the number of cycles for which the hose may be repeatedly pressurized to 25% of its burst pressure and then reduced to zero gauge pressure before failure of the hose, with each pressurization and depressurization constituting one cycle. The impulse test and equipment for conducting the impulse test are well known in the art.

Preferably, the hoses of the present disclosure are substantially non-deforming, such that the dimensions of the hose do not change when the pressure washing apparatus is operated at its rated burst pressure. Also, hoses of the present disclosure preferably have an elongation at their rated pressure of no more than about 5%, and more preferably no more than about 3%. Further, the volumetric expansion of the hose at the rated pressure preferably is no more than about 4.0 cc/ft., more preferably, no more than about 3.8 cc/ft., and most preferably, no more than about 3.5 cc/ft.

In the following examples, a center core 14 of polyethylene first is extruded followed by braiding or weaving a reinforcing layer 16 around the center core 14. For the hoses identified below with a fluid conduit diameter of 6.35 and 7.1 mm, the reinforcing layers are braids of polyester. For the hoses with a fluid conduit diameter of 7.3 mm and 9.2 mm, the reinforcing layer is 0.65 mm thick braid of polyester and 0.5 mm braid of metal wire. Next, a polyurethane outer jacket 12 is extruded over the reinforcing layer 16.

| Fluid | Center | Reinforcement | Outer |
|---|---|---|---|
| Conduit | Core Wall | Layer | Jacket Wall |
| Diameter | Thickness | Wall Thickness | Thickness |
| 6.35 mm | 1.0 mm | 0.8 mm | 1.0 mm |
| 7.1 mm | 1.25 mm | 1.7 mm | 1.0 mm |
| 7.3 mm | 1.7 mm | 1.15 mm | 1.0 mm |
| 9.2 mm | 1.7 mm | 1.15 mm | 1.2 mm |

It will be understood that the above examples are merely exemplary of the hoses of the present disclosure. Variations of these examples may become apparent to those of ordinary skill in the art upon reading the foregoing description. It will be appreciated that skilled artisans may employ such variations as desired, and hoses of the present disclosure may be constructed otherwise than as specifically described herein. Accordingly, all modifications and equivalents of the subject matter described herein are intended to be covered by the claims appended hereto as permitted by applicable law. Moreover, any combination of the above-described elements and all possible variations thereof are encompassed by the hoses of the present disclosure unless otherwise indicated herein or otherwise clearly contradicted by context.

What is claimed is:

1. A flexible hose comprising:
an outer jacket comprising a continuous layer having a plurality of protrusions extending radially outward from the continuous layer;
a center core separate from and disposed within the outer jacket;
wherein the protrusions are in spaced relation to one another and extend parallel to a longitudinal axis of the hose.

2. The flexible hose of claim 1 further comprising a reinforcing layer disposed between the center core and outer jacket.

3. The flexible hose of claim 1 wherein the plurality of protrusions are integrally formed with the continuous layer.

4. The flexible hose of claim 1 wherein each protective protrusion has a common thickness along its length.

5. The flexible hose of claim 1 wherein each protective protrusion has a generally rectangular shape.

6. The flexible hose of claim 1 wherein the plurality of protrusions are symmetrically spaced from one another.

7. The flexible hose of claim 1 further comprising a plurality of grooves defined between the plurality of protrusions, wherein the plurality of grooves extend parallel to the central axis of the hose, wherein each groove includes a floor and the floor of at least one the plurality of grooves is defined by an exposed surface of the continuous layer.

8. The flexible hose of claim 7 wherein a floor of at least one of the plurality of grooves is substantially flat.

9. The flexible hose of claim 7 wherein each of the plurality of grooves is narrower than each of the plurality of protrusions.

10. The flexible hose of claim 1 wherein the hose has a burst pressure of at least about 1000 psi.

11. A flexible hose comprising:
an outer jacket comprising at least one indicator surface area and at least one wear surface area, the at least one indicator and at least one wear surface areas being positioned adjacent one another;
a center core disposed within the outer jacket;
the indicator surface area being defined by an exposed surface of a continuous layer;
the wear surface area being defined by an exposed surface of a protrusion having a raised surface area relative to the indicator surface area, wherein the protrusion extends radially outward from the continuous layer; and
wherein the indicator surface area provides notice to a user of the continuous layer that will be exposed when at least a portion of the protrusion is worn through to expose the underlying continuous layer.

12. The flexible hose of claim 11 further comprising a reinforcing layer disposed between the center core and outer jacket.

13. The flexible hose of claim 11 wherein the protrusion is integrally formed with the continuous layer.

14. The flexible hose of claim 11 further comprising a plurality of spaced apart protrusions extending radially outward from the continuous layer.

15. The flexible hose of claim 14 wherein each of the protrusions has a common thickness along its length.

16. The flexible hose of claim 14 wherein the spaced apart protrusions define a plurality of grooves.

17. The flexible hose of claim 16 wherein each groove has a floor formed by the continuous layer.

18. The flexible hose of claim 16 wherein each of the plurality of grooves is narrower than each of the protrusions.

19. A method of detecting wear in an outer cover of a hose, the method comprising the steps of:
providing a hose having an outer jacket comprising a continuous layer having an exposed surface and a plurality of longitudinally extending protrusions connected to and extending radially outward from the continuous layer with the protrusions being in spaced relation to one another;
observing the exposed surface of the continuous layer before use of the hose; and
abrading a portion of at least one of the protrusions wherein more of the continuous layer is revealed in an area below the at least one protrusion.

20. The method of detecting wear in an outer cover of a hose of claim 18 wherein the hose further comprises a center core disposed within the outer jacket and a reinforcing layer disposed between the center core and outer jacket.
